(19) United States
(12) Patent Application Publication
(10) Pub. No.: US 2009/0035735 A1
(43) Pub. Date: Feb. 5, 2009

(54) SYSTEM AND METHOD FOR COMPUTERIZED TRAINING OF ENGLISH WITH A PREDEFINED SET OF SYLLABLES

(76) Inventors: Theodore G. Nollan, Soledad, CA (US); Genaro T. Nollan, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/247,168

(22) Filed: Oct. 7, 2008

Related U.S. Application Data
(63) Continuation of application No. 11/059,297, filed on Feb. 15, 2005, now abandoned.

(51) Int. Cl. G09B 17/00

(52) U.S. Cl. 434/178

(57) ABSTRACT

Systems and methods for computerized teaching of the English language are disclosed. The disclosed embodiments comprise presenting a predefined set of syllables representing the English language to a student visually and audibly such that the user learns to read and write each syllable. Furthermore, the student may be instructed to read and write words of the English language not included in the examples shown in front of each syllable utilizing their knowledge of the syllables.

### CROSS REFERENCE TO RELATED APPLICATIONS

This application is a continuation of U.S. application Ser. No. 11/059,297, titled “System and Method for Computerized Training of English with a Predefined Set of Syllables,” filed Feb. 15, 2005, the specifications of which is hereby incorporated herein by reference.

### BACKGROUND OF THE INVENTION

1. Field of the Invention

The invention relates to a computerized device and method for teaching persons to read, write, and/or speak the English language. More particularly, the invention relates to systems and methods that use computer software to teach the English language using a defined set of syllables that are stored in memory and presented to a user via an output device.

2. Description of the Related Technology

Illiteracy remains problematic among both children and adults in the United States despite the existence and use of teaching aids in the art. A number of teaching methods include breaking the English language into phonic sounds and identifying or highlighting phonemes for a user. Many teaching aids include specific combinations of visual and audio output to a learning user with regard to phonemes or syllables of given text. While a number of devices and programs fulfill their particular objectives, few result in timely and effective learning of the first steps of reading and writing.

### SUMMARY OF CERTAIN INVENTIVE ASPECTS

One embodiment of a computerized system for teaching the English language using a predefined set of syllables comprises a peripheral interface for receiving input data entered by a user on one or more peripheral devices and transmitting output data to a user on the one or more peripheral devices, wherein the peripheral devices including a microphone. The computerized system further comprises a program nonvolatile memory for storing an input processing module for receiving and processing input data from the peripheral interface and converting audio data to digital data, a speech recognition module for receiving the digital data corresponding to audio data received by the microphone and determining speech components representing the audio data, wherein the speech components comprise letters, syllables and words of the English language, a syllable storage area for storing a defined set of syllables representing the English language, a student response processing module for assessing the student's learning based on responses entered by the student, a teaching processing module for determining the syllables to teach the student based on the assessment of the student's learning, a results processing module for evaluating the student's performance, and a speech synthesis module for converting digital data to audio data and transmitting the audio data to the peripheral interface. The computerized system also comprises a processor for executing the input processing module, the speech synthesis module, the teaching processing module, the student response processing module, the results processing module, and the output processing module.

In some embodiments, the defined set of syllables representing the English language comprises 230 syllables, and at least one of the syllables may be accompanied by at least three example words illustrating that the same syllable can be found at the beginning of a first word, in substantially the middle of a second word, and at the end of a third word.

The peripheral devices may further comprise an external network connection for communicating with a remote system via a network so that student responses and results are monitored on the remote systems. The peripheral devices may also further comprise at least one speaker for playing audio data generated by the output processing module to the user.

One embodiment of a computerized method of teaching the English language, wherein the method utilizes a defined set of syllables representing the English language, comprises vocalizing each letter of the English alphabet to a student, instructing the student to write each letter of the English alphabet so that the student learns to correctly write each letter, teaching a defined set of syllables to the student so that the student learns to correctly read and write each syllable, vocalizing the defined set of syllables to the student and instructing the student to write the syllables so that the student learns to correctly write each syllable, instructing the student to read and write words of the English language utilizing the student's knowledge of the syllables, and instructing the student of exceptions in the English language for which the words are spelled differently than their syllabic sound. The defined set of syllables representing the English language may comprise 230 syllables.

A computerized method of teaching the English language using a predefined set of syllables comprises presenting a defined set of syllables to a student so that the student learns to correctly read and write each syllable; and vocalizing and displaying the defined set of syllables to the student, wherein each syllable has a unique sound and spelling.

The computerized method may further comprise instructing the student to write the syllables so that the student learns to correctly write each syllable, instructing the student to read and write words of the English language utilizing the student's knowledge of the syllables, and/or instructing the student of exceptions in the English language for which the words are spelled differently than their syllabic sound.

Teaching the defined set of syllables may comprise heuristically presenting to the student a plurality of exemplary words for each of the syllables. Also, at least one of the exemplary words may be associated with the syllable being taught at the beginning of the word. At least one of the exemplary words may be associated with the syllable being taught in the middle of the word, and at least one of the exemplary words may be associated with the syllable being taught at the end of the word.

### BRIEF DESCRIPTION OF THE DRAWINGS

The above and other aspects, features and advantages of the invention will be better understood by referring to the following detailed description, which should be read in conjunction with the accompanying drawings. These drawings and the associated description are provided to illustrate certain embodiments of the invention, and not to limit the scope of the invention.

FIG. 1 is a flowchart illustrating an accelerated process of teaching a student to read and write English.

FIG. 2 is a flowchart illustrating a training process using an accelerated syllabic or usage training approach as performed on an English teaching system such as shown in FIG. 3 (see below).

FIG. 3 is a block diagram of a teaching system that utilizes the accelerated approach of teaching the English language as described herein.

FIG. 4 is a block diagram of a program ROM of the English teaching system shown in FIG. 3 having various processing modules.

### DETAILED DESCRIPTION OF CERTAIN EMBODIMENTS

The following detailed description of certain embodiments presents various descriptions of specific embodiments of the present invention. However, the present invention can be embodied in a multitude of different ways. In this description, reference is made to the drawings wherein like parts are designated with like numerals throughout.

In some embodiments, the student hears the vocalization of the phonetic sound of each letter of the English alphabet, accompanied with certain examples given after each letter. When the student is learning the phonetic sounds of each letter, it is advantageous to also teach the student to write the letters of the alphabet in printed form. In such embodiments, it can be beneficial to teach the student the printed form of the letter “a,” for example, instead of borrowing the manuscript form which the student will rarely find in the printed words when reading beginner's books. This is beneficial as there are more words that start with “a” than any other vowel. Once the student learns to read and write each letter of the English alphabet, the concept of syllables can be introduced to the student.

Syllables refer to the individual sounds that make up words. For example, syllables can be made of one or more letters such as “a” (one letter) plus “ble” (three letters) to make up the word “able.” In other examples, the same syllable can be found in the beginning, in the middle, or at the end of different words. In one such example, the syllable “fa” in the word “fan” is at the beginning of the word. The same syllable “fa” can be in the middle and/or at the end of a word, as in the word “alfalfa.” “Fa” can also be found only at the end of a word, as in the word “sofa.” In the same way that the sounds of letters make up the sounds of syllables, syllables are the sounds or building blocks that make up the words in many languages.

In addition, the same syllable can have a different sound in different words, for example, the digraph “bi” in “big” has a different sound than the digraph “bi” in “bike.” Similarly, the digraph “che” in “chest” has a different sound than the digraph “che” in the word “ache.”

Writing of words is usually done with small (lower case) letters. Big letters (upper case or capital letters) are most often used at the beginning of a sentence, or in the first letter of a proper name such as “David.” A sentence is a complete thought such as “I have many toys,” An incomplete thought, such as “many toys,” is called a phrase. When one begins to write, the student is taught to try to write complete thoughts and end the sentences with a small dot called a period.

Some uncommon words such as “uxor,” “epiphyte,” “xanthous” and a few others that were used in the positioning of some syllables are used to instill in the student, right from the start, that the use of the English dictionary is very beneficial. It is left to the discretion of the teacher, tutor or parent to subsequently teach the student that the meaning of unfamiliar words can be understood by reading within the text of the sentence.

In certain embodiments, the teacher strongly recommends that the student sound a syllable, or syllables, and asks the student to write the syllable(s) correctly instead of requesting the spelling of words. Once the student has been taught the various syllabic entries and is then familiar with the spelling of all or most of them, the student can be tested to write any word of the English language. The student can simply write phonetically by using the phonetic resources of this simplified syllabic approach, and the student can write just about any word very soon with very few spelling errors, which is very good progress for a beginner student. The same memory recall of the syllables described herein can be applied to reading. The person monitoring the student's reading can make corrections of mispronounced words, as opposed to reading the text before the student tries to read for him or herself. In this manner, the student often discovers that it is possible to begin to read without any help by recalling all or most of the syllables presented in this approach.

The approach as described herein includes accelerating the first learning steps of reading and writing. Notwithstanding the simplification of this approach over traditional methods, the dedicated student having the proper instructions, as described herein, can learn the first steps of reading and writing much faster than students learning to read and write by traditional rote methods. The student can also learn the first steps of writing much faster and with fewer spelling errors by simply recalling all or most of the syllables of the accelerated approach, as the student relies less on memorizing the spelling of every letter in the words being taught.

Listed below are the letters of the English alphabet, followed by the sound of each of the letters:

### Aa Bb Cc Dd Ee Ff Gg Hh Ii Jj Kk Ll Mm Nn Oo Pp Qq Rr Ss Tt Uu Vv Ww Xx Yy Zz

ea ee eo oo
a sounds a like map, \dot{o} like ball, saw, or a like day.
b sounds b like baby.
c sounds c like cat, or s like cell.
d sounds d like dad.
e sounds e like bed, ē like even or ī like eye.
f sounds f like face.
g sounds g like go or gh like page.
h sounds h like hand.
i sounds i like if, or ī like ice.
j sounds j like job.
k sounds k like kid.
l sounds l like lake.
m sounds m like mother.
n sounds n like no.
o sounds o like boy, ö like no, or ä like box.
p sounds p like pet.
q sounds q like quick.
r sounds r like rain.
s sounds s like sand, or sh like sugar or ship.
t sounds t like ten.
u sounds \dot{u} like pull, u like union, or a like under.
w sounds w like water
x sounds cs like box, x ray.
y sounds y like yard or you.
z sounds z like zero or zoo
ea usually sounds e like easy except in words like ocean or crustacean.
ee sounds e like bee, keep or see.
eo sounds e like in the word people.
oo usually sounds u like in book except in the words blood, door, flood or floor,

The prosodic sound of each letter listed above is like the code of the alphabet that is used to combine the letters or utter the sound of just one letter to form syllables. For example, “a” (one letter) plus “sy” (two letters) plus “lum” (three letters) forms the word “asylum.” When a student is being taught for the very first time the letters of the alphabet, it is easier for a young child to process one single sound or meaning for each letter than two sounds for the same letter. For this reason, when teaching using this approach, it is beneficial to teach the student just the individual prosodic sounds of each letter as opposed to combining the prosodic sounds with the names of the letters of the alphabet, such as “a”, “bee” for the letter “b,” “cee” for the letter “c,” “dee” for the letter “d,” and so forth. The prosodic sounds of each individual letter of the alphabet listed above matches directly with single or combined phonetic sounds that form the syllables. For example, the sounds of the letters “ddd” for “d,” plus “a,” plus “ddd” for “d” again, form the sound for the word “dad.”However, using the sounds of the names of the same letters, the student would tend to form the word “dad” as “dee” for “d,” plus “a,” plus “dee” for “d” to form the incorrect word “dee-a-dee.” The student has to make such silent mental corrections to overcome these incoherencies. To facilitate these mental corrections, the student is not generally taught the well known ABCs jingle until after mastering the accelerated learning approach.

The various syllables that are defined in the accelerated approach are listed below, followed by examples showing each syllable used in several different words. As shown in the list below, the same syllable can appear at the beginning of some words, in the middle of some words, and at the end of some words while usually having substantially the same sound:

an and sand fan
en end bend ten
in ink pink fin
on only bone son
un under hungry bun
ar arm farm car
er erase fern over
ir Iraq circus fir
or orage corner color
ur urge curve fur
da dad today panda
de desk blender pride
di dig radio Lodi
do dog adobe judo
du duck endure kudu
ma map armadillo coma
me men camel home
mi milk smile salami
mo Monday lemon Eskimo
mu muumuu lemur emu
pa panda leopard opal
pe pet carpet cape
pi picnic spider okapi
po pony hippopotamus tempo
pu puma republic octopus
fla flag inflate flat
fle flesh muffler waffle
fli flick conflict inflict
flo floor sunflower afloat
flu flute influx reflux
bra branch library zebra
bre bread sombrero hombre
bri brick fabric bright
bro brother abroad fibro
bru brush February brunch
gra grass program pellagra
gre great egret ogre
gri grill pilgrim grid
gro grow aground allegro
gru gruesome congruent grub
wra wrap
wre wrench
wri wrist
wro wrong
wru wrung
kna knack
kne knead
kni knit knife knight
kno knock knot know
knu knuckle
qua quality square aqua
que question request torque
qui quick squirrel squid
quo quotient sequoia quote
va van oval ova
ve vegetable seven five
vi village divide anvil
vo volcano avocado salvo
za zap lizard pizza
ze zebra dozen prize
zi zipper quizzical Brazil
zo zone ozone kazoo
zu zucchini mazurka lazuli
ca cat pelican Inca
ce center ocelot dance
ci city special deci
co corn bacon taco
cu cup circular focus
ga garden sugar toga
ge get tiger age
gi give forgive magic
go gold begonia flamingo
gu gum jaguar August
fa fan alfalfa sofa
fe fern safety safe
fi fig goldfish fix
fo fork before fog
fu full refuge tofu
bla blast ablaze semblance
ble blend emblem table
bli blink blister oblige
blo block oblong pueblo
blu blue ablush blunt
pla plant eggplant display
ple plenty complete apple
pli plink compliment accomplish
plo ploy employee deploy
plu Pluto surplus plum
dra dragon hydrant tundra
dre dress address cadre
dri drink mandrill tendril
dro drone android andro
dru drupe quadruped quadru
tra trap central contra
tre trend strength centre
tri trip citric electric
tro tropical strong nitro
tru true citrus untrue
sha shark reshape ricksha
she shell cashew she
shi ship cushion sushi
sho short ashore show
shu shuffle reshuffle shut
ta tap potato manta
te ten enter minute
ti ticket mantis coati
to toy tortoise pinto
tu turtle lettuce tutu
ya yard loyal Maya
ye yellow player rye
yi yield playing saying
yo yolk coyote yoyo
yu yule cayuse Soyuz
tude altitude latitude longitude
tion action nation motion
tive active attentive receptive
ture lecture nature structure
tial essential initial partial
ba bath abate samba
be bed obey be
bi big cubic bambi
bo boy cowboy rainbow
bu bull fabulous buy
tha that lethargy Gotham
the the other bathe
thi this nothing ethic
tho those method python
thu thunder enthusiasm thus
na nap banana iguana
ne nest honest one
ni nick animal zucchini
no noise snow piano
nu nucleus January menu
la lamp island koala
le leg calendar handle
li lip pelican slit
lo log melon polo
lu lure elude lung
gla glass England glad
gle glen piglet ogle
gli glimpse English glim
glo glove aglow Anglo
glu glue englut glut
cra crayon scratch crab
cre crest concrete lucre
cri cricket script crib
cro cross macro micro
cru cruise recruit scrub
pra practice spray copra
pre press comprehend osprey
pri principal apricot April
pro progress improve apron
pru prune imprudent prude
ha hat behave aloha
he hen behemoth cache
hi hill behind mahimahi
ho horse cohort Idaho
hu hug inhuman Oahu
sa sac dinosaur visa
se seven present house
si sit inside pachisi
so soft season also
su super usual pursue
phra phrase diaphragm rephrase
phre phrenetic phrenic
phro nephron Aphrodite nephro
cial facial social special
sion permission session vision
sure assure leisure measure
ax ax taxes fax
ex exit next flex
ix ixtle mixer mix
ox oxen boxer sox
ux uxor exult tux
xa xanthous Texas exam
xe xenon boxer oxen
xi Ximenes exit taxi
ka kayak peekaboo polka
ke kettle market cake
ki kit pumkin ski
ko koala Dakota gecko
ku kudo ukulele skunk
ja jaguar ajar ninja
je jelly project eject
ji jig jujitsu kanji
jo joy enjoy banjo
ju July injury jump
pha pharmacy alphabet elephant
phe pheasant hyphen gopher
phi Philadelphia amphibian dolphin
pho photo telephone amphora
phy physics epiphyte trophy
cla class declare clam
cle clerk inclement circle
cli click recline clip
clo cloth cyclone clot
clu clue include club
ra rabbit orange camera
re red forest tire
ri rib caribou crib
ro rope brown taro
ru rule truth guru
fra frank refrain infra
fre fresh refresh fret
fri frigid Africa friend
fro frog defrost Afro
fru fruit breadfruit frugal
thra thrash anthrax
thre threat thread three
thri thrift thrill thrive
thro throat anthropoid through throw
thru thrust thruway
wha what whale wharf
whe when where wheat wheel
whi which whistle white
who who whole whopper
wa water Hawaii Ottawa
we wet twelve owe
wi wind swim kiwi
wo work sword two
wu wunderkind swum swung
cha chat mechanic concha
che chest hatchet ache
chi chicken machine chichi
cho chocolate anchovy nacho
chem chemical chemistry sachem
chlo chlorophyll schlock
chu chunk Machu Picchu
chri Christmas
chro chrome achromatic schrod

Once the student becomes familiar with the generic syllables or word particles, the teacher soon recognizes that students begin to read faster than students learning to read by rote methods. The advantages of the accelerated approach are apparent when the student finds that he or she can begin to write by simply recalling the syllables listed above. Students from other countries learning English as a second language using the accelerated approach can also more rapidly learn the reading and writing of long technical or scientific words by simply recalling the syllables listed herein with few or no spelling errors. For example, a student can read and write the word “neuropharmacological” from the syllables “ne u ro pha r ma co lo gi ca l,” or alternatively from the syllables “neu ro phar ma co log i cal.”

When the student is familiar with all or most of the syllables, the teacher can ask the student to write words that are not in the list above simply by sounding the syllables and the sounds of letters of the chosen word. As an example, the student can be asked to write the word “dependable” in the following way: “de pe nnn da ble,” showing the separation of its syllables, “de pend a ble,” forming the word “dependable.” The teacher can explain to the student that the “i” sound at the end of most words becomes “y,” except, for example, in the Latin plural of nouns, which can be taught at a later time, and other adopted foreign words. An example of the “i” sound at the end of a word is the word “fancy.” Using the syllables listed above, the spelling of the word “fancy” would be “fa n ci,” while the actual spelling of the word would be “fan cy” with the ending of the word with an orthographic “y” instead of the phonetic “i.” The student is preferably instructed that when the vowel “e” appears at the end of most words the “e” has no sound except when the “e” appears at the end of adopted French words, such as entrée, flambé, sauté, etc. When teaching with the accelerated approached as described herein, it can be advantageous not to ask the student to spell words, but to instead urge the student to write by the sound of the syllables of the words that the student may want to write plus the sounds of the letters that may be between the syllables of the chosen words.

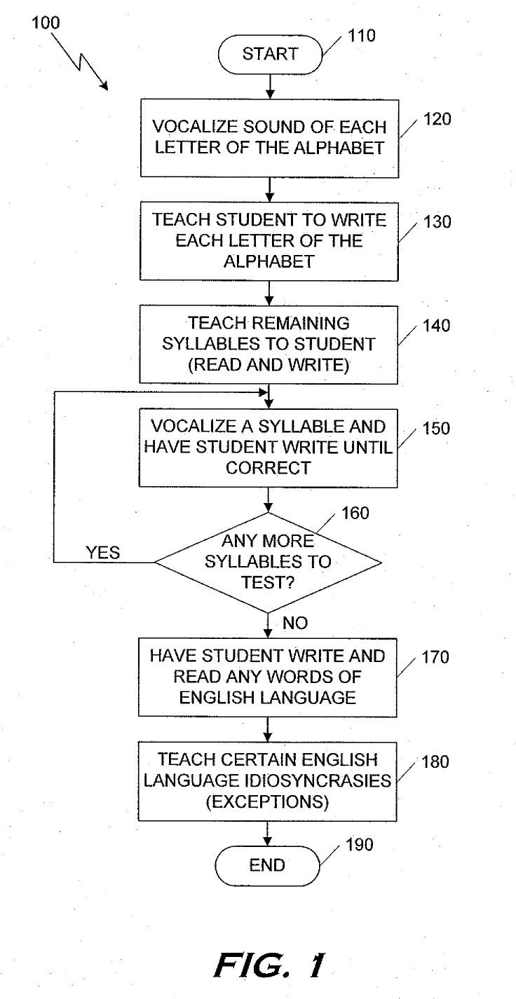

Referring now to the figures, FIG. 1 is a flowchart illustrating an accelerated process 100 of teaching a student to read and write English. The accelerated process 100 begins at a start block 110. At a block 120, the accelerated process 100 vocalizes the sound of each letter of the alphabet. The accelerated process 100 continues to a block 130 to teach the student to write each letter of the alphabet. At a block 140, the accelerated process 100 teaches the remaining syllables to the student, both for reading and writing purposes. The accelerated process 100 continues to a block 150 for vocalizing a certain syllable and having the student write the syllable until it is written correctly.

At a decision block 160, the accelerated process 100 determines whether there any more syllables on which to test the student. If it is determined at the decision block 160 that there are more syllables to test, the accelerated process 100 continues back to the block 150 as described above. However, if it is determined at the decision block 160 that there are not any more syllables to test, the accelerated process 100 continues to a block 170 to have the student write and read words of the English language. The accelerated process 100 continues to a block 180 for teaching certain English language idiosyncrasies or exceptions. The accelerated process 100 terminates at an end block 190.

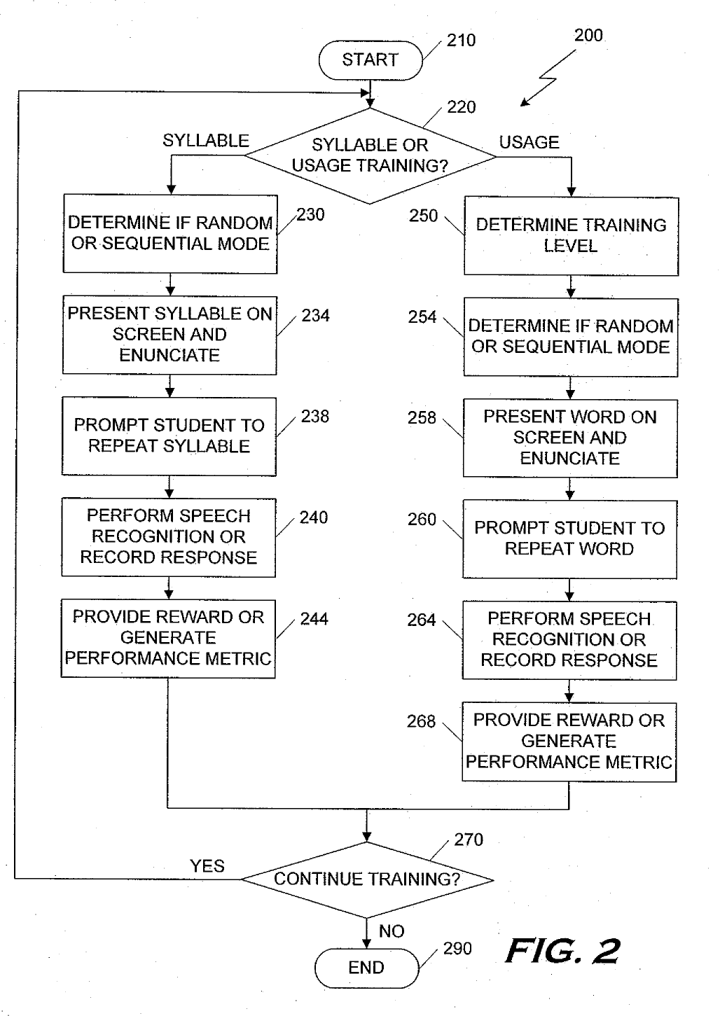

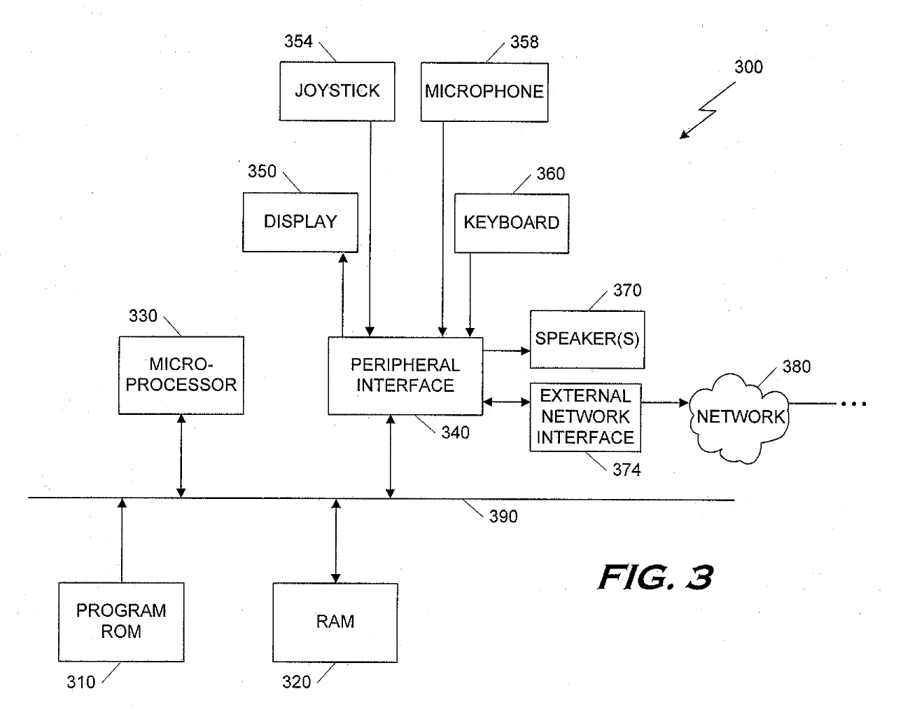

FIG. 2 is a flowchart illustrating a training process 200 using an accelerated syllabic or usage training approach as performed on an English teaching system such as shown in FIG. 3 (see below). The training process 200 begins at a start block 210. At a decision block 220, the training process 200 determines whether syllable training or usage training is performed. If it is determined at the decision block 220 that syllable training is to be used, the training process 200 continues to a block 230 to determine if random or sequential mode training is utilized. The training process 200 continues to a block 234 to present a syllable on the screen of the English teaching system and enunciate the pronunciation of the syllable. At a block 238, the training process 200 prompts the student to repeat the syllable as enunciated in the block 234. The training process 200 continues to a block 240 to perform speech recognition or record the response to the prompt of the block 238. At a block 244, the training process 200 provides a reward to the student for correctly pronouncing the syllable, or alternatively generates a performance metric, such as the number of syllables that the student correctly pronounced in proportion to the total syllables taught to the student.

However, if it is determined at the decision block 220 that usage training is to be used, the training process 200 continues to a block 250 to determine the training level of the usage training. For example, levels such as beginner, intermediate or advanced levels can be implemented. At a block 254, the training process 200 determines if random or sequential usage training is performed. The training process 200 continues to a block 258 to present the word to be taught on the screen of the English teaching system and enunciate the word to the student. The training process 200 continues to a block 260 to prompt the student to repeat the word that was presented and enunciated in the block 258. At a block 264, the training process 200 performs speech recognition or records the response provided by the student in response to the prompt given in the block 260. The training process 200 continues to a block 268 to provide a reward to the student for correctly pronouncing the word, or alternatively generate a performance metric, such as the number of syllables that the student correctly pronounced in proportion to the total syllables taught to the student.

After the block 244 or after the block 268, the training process 200 continues to a decision block 270 to determine whether to continue the training. If it is determined at the decision block 270 to continue the training, the training process 200 continues back to the decision block 220 as described above. However, if it is determined at the decision block 270 not to continue the training, the training process 200 terminates at an end block 290.

FIG. 3 is a block diagram of a teaching system 300 that utilizes the accelerated approach of teaching the English language as described herein. The embodiment of the teaching system 300 shown in FIG. 3 includes a program read-only memory (ROM) 310 for storing instructions that perform the operations as described for the training process 200 of FIG. 2. ROM refers to computer memory on which data has been prerecorded. Once data has been written onto a ROM chip, it can only be read and cannot be written. Unlike main memory, referred to as random access memory (RAM), ROM retains its contents even when the computer is turned off. Thus, ROM is referred to as being nonvolatile memory, whereas RAM is volatile memory. Other embodiments can include a variation of a ROM that is referred to as a programmable read-only memory (PROM). PROMs are manufactured as blank chips on which data can be written with a special device called a PROM programmer. In further embodiments, other memory devices such as flash memory, erasable programmable read-only memory (EPROM), electrically erasable programmable read-only memory (EEPROM), and the like, can be utilized.

The teaching system 300 shown in FIG. 3 includes a random access memory (RAM) 320 for storing dynamic data. As RAM is volatile memory, the data stored on the RAM 320 is not retained when power is removed from the teaching system 300. The teaching system 300 further comprises a microprocessor 330 configured to execute programs and modules stored at the program ROM 310 in conjunction with the RAM 320. The microprocessor 330 may be any conventional general purpose single- or multi-chip microprocessor such as a Pentium® processor, a Pentium® Pro processor, a 8051 processor, a MIPS® processor, a Power PC® processor, or an ALPHA® processor. In addition, the microprocessor may be any conventional special purpose microprocessor such as a digital signal processor or a graphics processor. The microprocessor typically has conventional address lines, conventional data lines, and one or more conventional control lines.

The teaching system 300 further comprises a peripheral interface 340 configured to communicate with a plurality of peripheral devices so as to receive in put data entered by a user on one or more peripheral devices and to transmit output data to the user on one or more peripheral devices. The plurality of peripheral devices may include a display 350, a joystick 354, a microphone 358 configured to receive audio input, a keyboard 360, and a speaker(s) 370. The peripheral devices may communicate with the peripheral interface via a plurality of communication means, including both wired and wireless communication links. The plurality of peripheral devices may also include an external network interface 374 configured to facilitate communications over a network 380. The program ROM 310, RAM 320, microprocessor 330, and peripheral interface 340 communicate over a communication bus 390.

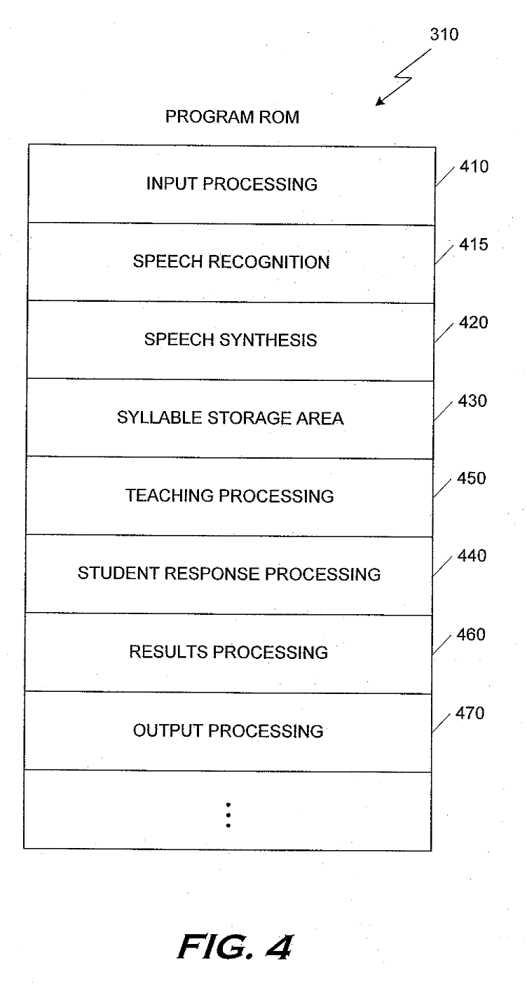

FIG. 4 is a block diagram of an exemplary program ROM 310 of the English teaching system 300, wherein the program ROM 310 comprises a plurality of processing modules. As can be appreciated by one of ordinary skill in the art, each of the modules comprises various sub-routines, procedures, definitional statements and macros. Each of the modules are typically separately compiled and linked into a single executable program. Therefore, the following description of each of the modules is used for convenience to describe the functionality of one embodiment of the system. Thus, the processes that are undergone by each of the modules may be arbitrarily redistributed to one of the other modules, combined together in a single module, or made available in, for example, a shareable dynamic link library.

The program ROM 310 comprises an input processing module 410 configured to process input data from the peripheral devices via the peripheral interface 340. The input processing module 410 may be further configured to convert audio or analog data received from a peripheral device to digital data. The program ROM 310 further comprises a speech recognition module 415 configured to receive the digital data corresponding to audio data received at the microphone 358. The speech recognition module 415 is further configured to determine speech components representing the audio data, wherein the speech components comprise letters, syllables, and words of the English language. Also included at the program ROM 310 is a speech synthesis module configured to convert digital data to audio data and transmit the audio data to the peripheral interface 340. The audio data transmitted to the peripheral interface 340 may be outputted to the user at the speakers 370, for example.

The program ROM 310 further comprises a syllable storage area 430 configured to store a defined set of syllables representing the English language, such as the syllables listed above. Also included at the program ROM 310 is a student response processing module 440 configured to assess a student's learning based on responses entered by the student at one or more of the peripheral devices 354, 358, 360. In addition to the student response processing module 440, the program ROM 310 also comprises a teaching processing module 450 configured to determine the syllables to teach a student based on the assessment of the student's learning performed by the student response processing module 440, for example. The program ROM 310 further comprises a results processing module configured to evaluate the student's performance, for example, based on input received at the microphone 358, keyboard 360, and/or joystick 354.

The microprocessor 330 is configured to execute the input processing module 410, the speech recognition module 415, the speech synthesis module 420, the teaching processing module 450, the student response processing module 440, the results processing module 460, and the output processing module 470 in accordance with the accelerated process 100 and training process 200 of FIGS. 1 and 2, for example.

While the above detailed description has shown, described, and pointed out novel features of the invention as applied to various embodiments, it will be understood that various omissions, substitutions, and changes in the form and details of the device or process illustrated may be made by those skilled in the art without departing from the intent of the invention.

What is claimed is:

1. A computerized system for teaching the English language using a predefined set of syllables, the system comprising:
a peripheral interface for receiving input data entered by a user on one or more peripheral devices and transmitting output data to a user on the one or more peripheral devices, the peripheral devices including a microphone;
a program nonvolatile memory for storing:
an input processing module for receiving and processing input data from the peripheral interface and converting audio data to digital data,
a speech recognition module for receiving the digital data corresponding to audio data received by the microphone and determining speech components representing the audio data, wherein the speech components comprise letters, syllables and words of the English language,
a syllable storage area for storing a defined set of syllables representing the English language,
a student response processing module for assessing the student's learning based on responses entered by the student,
a teaching processing module for determining the syllables to teach the student based on the assessment of the student's learning,
a results processing module for evaluating the student's performance, and
a speech synthesis module for converting digital data to audio data and transmitting the audio data to the peripheral interface; and
a processor for executing the input processing module, the speech synthesis module, the teaching processing module, the student response processing module, the results processing module, and the output processing module.

2. The system of claim 1, wherein the defined set of syllables representing the English language comprises 230 syllables.

3. The system of claim 2, wherein at least one of the syllables is accompanied by at least three example words illustrating that the same syllable can be found at the beginning of a first word, in substantially the middle of a second word, and at the end of a third word.

4. The system of claim 1, wherein the peripheral devices further comprise an external network connection for communicating with a remote system via a network so that student responses and results are monitored on the remote systems.

5. The system of claim 1, wherein the peripheral devices further comprise at least one speaker for playing audio data generated by the output processing module to the user.

6. A computerized method of teaching the English language, the method utilizing a defined set of syllables representing the English language, the method comprising:
vocalizing each letter of the English alphabet to a student;
instructing the student to write each letter of the English alphabet so that the student learns to correctly write each letter;
teaching a defined set of syllables to the student so that the student learns to correctly read and write each syllable;
vocalizing the defined set of syllables to the student and instructing the student to write the syllables so that the student learns to correctly write each syllable;
instructing the student to read and write words of the English language utilizing the student's knowledge of the syllables; and
instructing the student of exceptions in the English language for which the words are spelled differently than their syllabic sound.

7. The method of claim 6, wherein the defined set of syllables representing the English language comprises 230 syllables.

8. The method of claim 7, wherein the set of syllables comprises:
a b c d e f g h i j k l m n o p q r s t u v w x y z ea ee eo oo an en in on un ba be bi bo bu ar er ir or ur tha the thi tho thu da de di do du na ne ni no nu ma me mi mo mu la le li lo lu pa pe pi po pu gla gle gli glo glu fla fle fli flo flu era cre cri cro cru bra bre bri bro bru pra pre pri pro pru gra gre gri gro gru ha he hi ho hu wra wre wri wro wru kna kne kni kno knu qua que qui quo va ve vi vo za ze zi zo zu sa se si so su phra phre phro cial sion sure ax ex ix ox ux xa xe xi ca ce ci Co cu ka ke ki ko ku ga ge gi go gu ja je ji jo ju fa fe fi fo fu pha phe phi pho phy bla ble bli blo blu cla cle cli clo clu pla ple pli plo plu ra re ri ro ru dra dre dri dro dru fra fre fri fro fru tra tre tri tro tru thra thre thri thro thru sha she shi sho shu wha whe whi who ta te ti to tu wa we wi wo wu ya ye yi yo yu tude tion tive ture tial cha che chi cho chem chlo chu chri chro.

9. A computerized method of teaching the English language using a predefined set of syllables, the method comprising:
presenting a defined set of syllables to a student so that the student learns to correctly read and write each syllable; and
vocalizing and displaying the defined set of syllables to the student, wherein each syllable has a unique sound and spelling.

10. The method of claim 9, further comprising instructing the student to write the syllables so that the student learns to correctly write each syllable.

11. The method of claim 9, further comprising instructing the student to read and write words of the English language utilizing the student's knowledge of the syllables.

12. The method of claim 9, further comprising instructing the student of exceptions in the English language for which the words are spelled differently than their syllabic sound.

13. The method of claim 9, wherein teaching the defined set of syllables comprises heuristically presenting to the student a plurality of exemplary words for each of the syllables.

14. The method of claim 13, wherein at least one of the exemplary words is associated with the syllable being taught at the beginning of the word.

15. The method of claim 13, wherein at least one of the exemplary words is associated with the syllable being taught in the middle of the word.

16. The method of claim 13, wherein at least one of the exemplary words is associated with the syllable being taught at the end of the word.
